(19) United States
(12) Patent Application Publication
(10) Pub. No.: US 2009/0078323 A1
(43) Pub. Date: Mar. 26, 2009

(54) Air discharge device

(76) Inventor: Billy Joe Davis, Marysville, OH (US)

Correspondence Address: Billy Joe Davis, 17360 West Darby Road, Marysville, OH, 43040, US

(21) Appl. No.: 11/903,449

(22) Filed: Sep. 22, 2007

(51) Int. Cl. B67D 5/54

(52) U.S. Cl. 137/209

(57) ABSTRACT

My inventive property is a tool to expel residual liquid from larger diameter hose, pipe or any other defined tubular conduit such as Fire Hose or Lay Flat PVC Hose, therefore dramatically reducing the weight of said conduit prior to retrieval and defined storage. All prior art fails to solve problems with reducing the time and labor required to remove residual liquid from said conduit without lifting the entire length to a point above the end (“Walking Out”) so gravity can remove residual liquid or by using a roller on the entire length of said conduit. My inventive property is comprised of five essential parts; a Gas Containment Vessel, a Safety Relief Valve, a Gas Fill Valve, a Gas Outlet Control Valve and a Final Stage Outlet Conduit Connection Adaptor.

### REFERENCES

| | | |
|---|---|---|
| 984725 | HOSE DRIER | FEB. 21, 1911 |
| 2702201 | HOSE ADAPTER COUPLING FOR FAUCET SPIGOTS | FEBRUARY 1955 |
| 3101091 | MOISTURE EJECTION VALVE | AUGUST 1963 |
| 3601038 | FIREHOSE RETRACTOR | AUGUST 1971 |
| 1495671 | SAFETY CAP FOR WATER TRAPS FOR GAS PIPES | MAY 1974 |
| 3866532 | FIREHOSE RETRACTOR | FEBRUARY 1975 |
| 4239184 | VALVE STEM | DEC. 16, 1980 |
| 4246926 | APPARATUS FOR REMOVING RESIDUAL WATER . . . | JAN. 27, 1981 |
| 4355652 | PURGING DEVICE | OCT. 26, 1982 |
| 4755112 | WATER/AIR PUMPING SYSTEM | JUL. 5, 1988 |
| 4776362 | RELIEF VALVE FOR FLUID LINE | OCT. 11, 1988 |
| 4809732 | FITTING FOR CLEARING WATER FROM FLUID . . . | MAR. 7, 1989 |
| 4881567 | LIQUID REMOVAL SYSTEM | NOV. 21, 1989 |
| 5154936 | APPARATUS FOR EVERTING A TUBE | OCT. 13, 1992 |
| 5247963 | FLUSH APPARATUS FOR WATERING SYSTEMS | SEP. 28, 1993 |
| 5358359 | APPARATUS FOR EVERTING A TUBE | OCTOBER 1994 |
| 5433246 | PRESSURE COUPLING FOR CLEANING WATER LINES | JULY 1995 |
| 5390691 | BLEED VALVE FOR WATER SUPPLY FOR CAMPING . . . | FEB. 21, 1995 |
| 5433246 | PRESSURE COUPLING FOR CLEANING WATER LINES | JUL. 18, 1995 |
| 5598867 | METHOD AND APPARATUS FOR DRAINING . . . | FEB. 4, 1997 |
| 5857480 | WATER PURGING SYSTEM | JAN. 12, 1999 |
| 6237620 | CONDUIT FOR PRESSURIZING PLUMBING SYSTEMS . . . | MAY 29, 2001 |
| 6390795 | APPARATUS FOR EVERTING A TUBE | MAY 21, 2002 |
| 6591744 | WHEELED SQUEEGEE FOR FIRE HOSE | JUL. 15, 2003 |
| 6761163 | INFLATOR REGULATOR WITH MULTIPLE . . . | JUL. 13, 2004 |
| 7198057 | FREEZE-FREE WATER HOSE | APR. 3, 2007 |

### DESCRIPTION OF THE PRIOR ART

All prior art has no direct reference to my invention or fails to solve outline problems and there is no prior art that will provide the requirements listed herein. Prior art examples do not use principles of pressure combined with volume capacities and other essential requirements that apply to larger diameter hose, pipe or any other tubular conduits that contain residual water or any other liquid that needs to be purged or evacuated for any reason whatsoever. Some examples are:
a: U.S. Pat. No. 4,246,926—Apparatus for removing residual water from a water system. This prior art fails to meet the requirements outlined in my inventive property. The principles of this apparatus will only work for small diameter, rigid and straight pipe and will only be effective if the apparatus is attached to the highest point of the plumbing system. Whereas my inventive property works efficiently and effectively with larger diameter hose, pipe or any other tubular conduits with a plurality of bends, turns and low-to-high points typical of natural peaks and depressions of terrain.
b: U.S. Pat. No. 4,355,652 Purging device. This device fails meet the requirements of portability and transportability required for use in the field where hose, pipe or any other tubular conduits are used. This device must be permanently plumbed into the system and must have a series of valves and must be used with a separator tank system that traps liquid in a holding tank. My inventive property is portable and transportable to any field operation where liquids, such as water, must be purged or evacuated from hose, pipe or any other tubular conduits.
c: U.S. Pat. No. 4,809,732 Fitting for clearing water from fluid containing systems. The principles of this fitting require a permanently installed inlet and plurality of outlets to clear water from an under-ground sprinkler system to avoid freezing in cold weather. Not only does this fail portability and transportability requirements, but will only work with small diameter pipe in a fixed location.
d: U.S. Pat. No. 4,881,567 Liquid removal system. This system also fails to meet the requirements of my inventive property in that it requires a permanently installed access point such as a “tap hole” and also requires the insertion of a flexible conduit into the pipe needing liquid removal. It also requires a “combination of highly flexible, low-friction tube fitted with an internal stainless steel stiffener” length of tubing that is inserted through the permanently installed “tap hole” that must then be sealed off to prevent gas dispersal during the process. Cannot be portable, transportable or adaptable and does not use essential principles for it to work in the field of my inventive property.
e: U.S. Pat. No. 5,433,246 Pressure coupling for cleaning water lines. This pressure coupling fails to meet the requirements of my inventive property and is merely a coupling for attaching an air hose to a water faucet. This prior art even fails to meet its own requirements because there is no mention of an outlet to expel water from the plumbing system that would be required for the invention to work at all.
f: U.S. Pat. No. 5,857,480 Water purging system. This system fails to meet the requirements of my inventive property and is yet another permanently installed system for purging or evacuating water from a plumbing system. It is not portable, transportable or usable in the field for larger diameter hose, pipe or any other tubular conduits that contain residual water or any other liquid that needs to be purged or evacuated for any reason whatsoever.

### BACKGROUND OF THE INVENTION

I identified a drastic need for a labor saving device to reduce the physical labor-intensive manor of evacuating water or any other liquids from fire hose, lay flat hose, piping or any other tubular conduits after use and being charged with water or liquid of any type whatsoever and before retrieving, winding, folding, stacking, stowing or storing the said tubular conduit. All prior art is deficient in that there is simply no prior art that will solve problems associated with conduits used to move liquid from one point to another in the field and need to be evacuated of the weight associated with residual liquids prior to stowing or temporary storage of said conduits.

By evacuating the weight of residual liquid from the conduit first, the labor associated with retrieving, winding, folding, stacking, stowing or storing the conduit is dramatically reduced. For nearly one quarter of a century in the business of transporting water as my business I searched for a device or method to efficiently evacuate or expel residual water from tubular conduits to save the time and physical labor associated with “walking out” hose or other tubular conduit and overcome the effects of gravity that traps liquid in the in low laying portions of said conduit.

Through the lengthy processes of experimentation, trial and error, I invented a device for my own personal use that efficiently evacuates the said liquids by discharging non-combustible compressed gas from Gas Containment Vessel storage tank of the specific size required to permit a single or plurality of uses and still be portable. Simply applying air pressure to one end of the tubular conduit does not work since depressions in the terrain trap liquid in the tubular conduit and compressed gas alone will not move much of this trapped liquid to the end of the tubular conduit. I alone discovered that by applying principles of pressure, volume and other easy to understand formulas, the residual liquid could be expelled from the tubular conduit quickly and efficiently without the routine physical labor previously required.

I alone further discovered inflation for my inventive property can range from SCBA compressed air tanks, air compressor of any type or any style of stored non-combustible gas through any method and with the appropriate adaptor that would apply to the type of filling device used. This unique, never before discovered inventive device applies methods achieved by pressure plus volume and other formulas required or dependent upon the size, type, style, length and rigidity of various tubular conduits. Potential users of my inventive property range from fire fighters, construction workers, public disaster or city and Government agencies such as flood relief and many more.

A few of these potential users would include but would not be limited to: Contractors in the areas of Bridge Construction, Road Construction, Ponds, Residential Building, Commercial Building and Site Preparation, Basement and Foundation Construction, Airport Construction, Excavation, Masonry, Hydro Seeding. Underground Tank Removal or General Contractors. In the Food Industry—FDA Certified Lay Flat Hose for Meat Processing and Packing Plants, Potato Slurry Transport & Tank Discharge, Creamery Washdown Hose, Citrus Fruit Industry, Vineyard Industry, Fishing Industry, Transport of Used Cooking Oils to be Processed for Fuels. In the Commercial Marine Industry—Commercial Shipping, Merchant Marines, Yachting, Channel Homes, Emergency Bilgeflex Hose for electric and hand pumps, Medium and Light Duty Sanitary System Pumping, Oil Spill Containment, First Response Harbor Boats and Launches and First Response Dock Vehicles. In the Services Industry—Flooded Basement Pumping, Trucked Water for Swimming Pools, Water Tanker Rentals, Mobile Irrigation During Drought, Septic System Services, Grey Water Disposal. Local, City & County Governments—Fire Stations numbering more than 49,000 just in the USA, Water Treatment Facilities, Sewer Maintenance, Swimming Pools, Parks & Recreation Departments, Roads & Grounds, First Response Disaster Relief. State Government—Road and Highway Repair & Maintenance, Fish & Game Commissions, Parks & Recreation, Homeland Security First Response Equipment, State Environmental Protection Agencies, Army & Air National Guard, Wild Life Protective Services, Public Utilities Commissions. Federal Government—Forestry Service, Department of Agriculture, Soil & Water Conservation Districts, National Resource Conservation Services, National Parks, National Disaster Services, Homeland Security, Department of the Interior, Wild Life Habitat Conservation, Lands and Highways, Fire and Aviation Management, Army (to include The Corps of Engineers), Air Force, Navy, Marine Corps, Coast Guard, Military Installation Maintenance Facilities. Any or all other Private, Commercial or Government entities that use defined tubular conduit that must be purged of residual liquid prior to retrieval, winding, folding, stacking, stowing or storing the said conduit. Further, there are a potentially unlimited number of other existing, future or undiscovered users of my inventive property and, as obviated above, the needs and uses by amateurs or professionals are virtually endless and there are unlimited applications undiscovered at this time for my Air Discharge Device to purge, evacuate or expel liquid of any type from hose, pipe or any other tubular conduit whatsoever.

### BRIEF SUMMARY OF THE INVENTION

My invention is an Air Discharge Device to evacuate residual water or any other liquid whatsoever after the use from hose, pipe or any other defined tubular conduit whatsoever after use and before retrieving, winding, folding, stacking, stowing or storing the said conduit. There is no prior art that addresses problems resolved by my inventive property including but not limited to overcoming the effects of gravity when residual liquids are trapped in low laying portions of defined tubular conduit used in the field. Previous to my inventive property, the entire length of flexible tubular conduit had to be raised above the end of said tubular conduit by physically “walking out” or “rolling out” its entire length. These and all other scenarios are extremely time consuming and labor intensive. My inventive property is comprised of mechanically fabricated parts of any requirement driven size, shape or composition whatsoever including all synthetic materials, plastics, metals or future undiscovered materials. The potential uses and users of my inventive property are virtually endless.

### BRIEF DESCRIPTION OF DRAWING

The single drawing of my inventive property contains five figures to illustrate the critical parts required for the Air Discharge Device to be used in the manner described and as intended to evacuate or discharge residual liquid of any type whatsoever from any size or shape of hose, pipe or other tubular conduit as previously defined herein.

FIG. 1 illustrates a Gas Containment Vessel holding tank for compressed non-combustible gas that is of the appropriate size to contain the applicable amount, volume and pressure of said compressed non-combustible gas for single or a plurality of uses. Specific size relationship cannot be illustrated due to formula variables related to listed particular requirements.

FIG. 2 illustrates a safety pressure relief valve to prevent over filling the application specific capacities of the Gas Containment Vessel holding tank.

FIG. 3 illustrates a Gas Fill Valve that can be of any type, style or configuration to charge the Gas Containment Vessel holding tank with the applicable amount, volume and pressure of said compressed non-combustible gas for single or a plurality of uses.

FIG. 4 illustrates the Gas Outlet Control Valve Ensemble and Housing for release of compressed non-combustible gas by any manual or automatically controlled means whatsoever.

FIG. 5 illustrates the Final Stage Outlet Conduit Connection Adaptor that can be, but not limited to the connection of any adaptor whatsoever required to temporarily or permanently attach any style or type of connector to said outlet. Examples of the connectors include but are not limited to various or a plurality of, currently available connectors for PVC lay flat hose, fire hose, mill hose or any other means to connect the previously defined tubular conduit of any size or shape to the Air Discharge Device. Further, the Final Stage Outlet Conduit Connection Adaptor is adaptable for any other undiscovered present or future means to connect any hose, pipe or other tubular conduit to the Air Discharge Device.

### DETAILED DESCRIPTION OF THE INVENTION

My inventive property resolves many problems associated with the removal of residual liquids from hose, pipe or any other tubular conduit used to transport said liquids from one point to another in the field. One of numerous problems resolved by my inventive property is with the use of flexible tubular conduit, such as but not limited to Lay Flat PVC or Fire Hose, over rolling terrain and the large volume of liquid trapped in the conduit by low laying areas of said terrain. Since there is no existing prior art designed to remove residual liquids from tubular conduit in the field prior to retrieval, winding, folding, stacking, stowing or storing the said conduit, the process of making my inventive property has never been disclosed or documented before and includes five essential elements with a plurality of ancillary optional attachments. Encompassed in my inventive property is the ability to modify or adapt the outlet to be temporarily or permanently retrofit to any Tubular Conduit by means of commercially available or custom made adaptive fittings for the connection of said Tubular Conduit to the Final Stage Outlet Conduit Connection Adaptor (FIG. 5).

Specific use of my inventive property is to expel residual liquid from a tubular conduit in situations or scenarios where gravity cannot affect this process and in particular to avoid spending the time or manual labor to lift the tubular conduit to a point where gravity would overcome weight, mass and volume of said Residual Liquid. It should be intuitively obvious that an outlet for expelled residual liquid be a provisioning factor for use of this device. This provisioning factor can range from the open end of a hose that is coupled to the outlet of my device to an array of open valves at the opposing ends of a plurality of tubular conduits. The uses of my inventive property are truly endless and, as stated, there is no prior art that can achieve the said results.

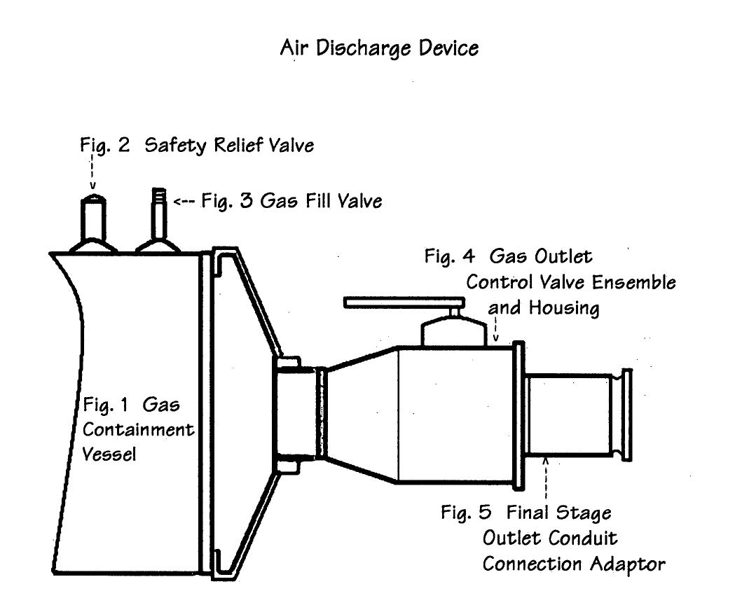

Once the tubular conduit is connected to the outlet of my inventive property, the Gas Outlet Control Valve (FIG. 4) is partially opened, manually or by automated means, to provide a situation-specified degree of gas pressure into the tubular conduit that requires removal of residual liquid. Once this process has forced the majority of residual liquid from the tubular conduit, the Gas Outlet Control Valve is more fully opened, by manual or automated means, to apply a situation-specified degree of gas volume into the tubular conduit resulting in a fine mist of residual liquid expelled from the Tubular Conduit. After residual liquid is sufficiently expelled, the Gas Outlet Control Valve is, manually or by automated means, closed in preparation for its next use or, if required, re-filling of the Gas Containment Vessel (FIG. 1).

Factors required for choice of Gas Containment Vessel size include diameter and length of the tubular conduit to be purged of residual liquid and the number of uses desired before re-filling is required. Re-filling the Gas Containment Vessel is simplified by the retrofit Safety Relief Valve (FIG. 2) that is pre-set to the maximum operating pressure of the Gas Containment Vessel thus allowing maximum flexibility for choosing the source of pressurized non-combustible gas. Such sources include but are not limited to SCBA or SCUBA tanks, portable or fixed air compressors, heavy vehicle air brake systems, air sources typical to firefighting apparatus or any other source of compressed non-combustible gas with the correct adaptive connector to the Gas Fill Valve (FIG. 3).

The composition of materials used to manufacture my inventive property can be, but are not limited to metal, plastic, carbon fiber or any other material whatsoever that complies with required strength and durability to include any other currently available or future discovered materials. Parts can be attached to each other by welding, bonding, gluing, with threaded connections or any other suitable means whatsoever as long as attachment points accommodate specified gas pressures for safe and durable assembly.

As illustrated in a single drawing, the essential elements of my inventive property are: A Gas Containment Vessel (FIG. 1) that must be of the appropriate size and capable of containing pressurized non-combustible gas of any type whatsoever and filled to the appropriate pressure for the specific use. A Safety Relief Valve (FIG. 2) to ensure the Gas Containment Vessel is not over filled during use in the field. A Gas Fill Valve (FIG. 3) of the appropriate type for filling or re-filling the Gas Containment Vessel for a plurality of uses. A Gas Outlet Control Valve Ensemble and Housing (FIG. 4) mounted linearly between the Gas Containment Vessel and the outlet of the device. A Final Stage Outlet Conduit Connection Adaptor (FIG. 5) of any specific type, style or other size required for connection of the Air Discharge Device to any hose, pipe or other defined tubular conduit that needs residual liquid removal or expulsion.

Definitions of Inventive Property Specific Terms: “Residual Liquid” can be any non-flammable fluid either in its purest state or with solids from the molecular level up to small chunks of debris that are either suspended or sedimentary. “Tubular Conduit” can be any rigid or flexible hose, pipe or other conduit used to transport a liquid from one point to another point that is in-place either on a permanent or temporary basis. “Users” of my inventive property are any entity or individual in need of evacuating said Residual Liquid from said Tubular Conduit and would be most typically prior to retrieval, winding, folding, stacking, stowing or storing the said Tubular Conduit but would also be for any other reason whatsoever. “Additional Formulas” include but are not limited to a determination by the “User” and simply based upon specific field requirements such as lay-of-the-land or number of uses before re-filling is required and not derived by mathematical algorithms or logarithms so the end user does not need to apply exacting mathematical formulas to determine when the Gas Containment Vessel requires re-filling. “Ancillary Optional Attachments” include but are not limited to; a handle, strap, harness or sling to transport the device in the field, a plurality of feet permanently or temporarily attached to the device, gas pressure gauge or other instrument to augment the Safety Relief Valve, any automated system to control the outlet control valve, adaptive couples or fittings to accommodate attachment of any Tubular Conduit or a means to attach the device permanently or temporarily to any size of vehicle, watercraft, cart, trailer or any other apparatus required to transport the device to the location of use.

1. What I claim as my invention is a unique, simplistic Air Discharge Device to expel water or any other liquid for use with various and all types of hose, pipe or any other defined tubular conduit including but not limited to fire hose, PVC lay flat hose as well as any future undiscovered types or styles of tubular conduit made of any material whatsoever. I further claim unlimited portable, transportable or fixed potential uses of this invention including uses not yet discovered as my inventive intellectual property and there is no prior art that will provide these said requirements by using the principles of pressure, volume and other defined formulas. Specifically I claim as my invention a unique labor and time saving device to evacuate any liquid from any type, style or size of hose, pipe or any other defined tubular conduit whatsoever by discharging compressed air or any other non-combustible gas from the invention's gas containment vessel by the manual or automatic opening of the device's control valve and introducing any type of previously defined gas into the previously defined tubular conduit by any adaptive connection not any exact size style type or material into the said conduit to be evacuated of its residual liquid. The expulsion, dispersal, purging or evacuation of residual liquid has never before been achieved combining pressure, volume and other formula principles. My inventive property can be portable, fixed or vehicle mounted and transported to the site of use by any means whatsoever.
